(19) United States
(12) Patent Application Publication
(10) Pub. No.: US 2003/0169023 A1
(43) Pub. Date: Sep. 11, 2003

(54) Circuit for reducing switching losses in electronic valves

(76) Inventors: Wolfgang Croce, Graz (AT); G?uuml;nther Danhofer, Graz (AT)

Correspondence Address: D Douglas Price, Steptoe & Johnson, 1330 Connecticut Avenue N W, Washington, DC, 20036, US

(21) Appl. No.: 10/257,278

(22) PCT Filed: Apr. 12, 2001
(86) PCT No.: PCT/AT01/00106

(51) Int. Cl. G05F 1/12

(52) U.S. Cl. 323/249

(57) ABSTRACT

The invention relates to a circuit for reducing the switching losses of electronic valves, a saturation coil (2) for reducing the switch-on losses being arranged in series with the electronic valve (1). In order to reduce both the switch-on and the switch-off losses as effectively as possible, it is provided that, via a capacitor (4), an electronic auxiliary valve (3) is arranged in parallel with the electronic valve (1) and a series circuit comprising at least an inductance (6) and a diode (7) for discharging the capacitor (4) is arranged in parallel with the electronic auxiliary valve (3), the electronic auxiliary valve (3) being driven before the switch-off operation of the electronic valve (1), so that the auxiliary valve (3) accepts the current flowing through the electronic valve (1) and the power loss of the electronic valve (1) is thus minimized during the switch-off operation. In an advantageous manner, a saturation coil (5) for reducing the switch-on losses of the auxiliary valve (3) is also arranged in series with the latter.

The application relates to a circuit for reducing the switching losses of electronic valves, a saturation coil for reducing the switch-on losses being arranged in series with the electronic valve.

The term electronic valves subsumes controlled and uncontrolled semiconductor components. The controlled semiconductor components are controlled either by the electric current fed to an electrode or by the electrical potential applied to such an electrode. They include for example bipolar and unipolar transistors, thyristors or comparable electronic components. Diodes, in which the current is a function of the voltage, are included in the uncontrolled electronic valves, for example.

Various losses occur during the switching or control of such semiconductor components. A distinction is made between on-state losses, on the one hand, and switching losses, on the other hand. The on-state losses predominate in the case of a low switching frequency and long activation times, while at higher switching frequencies the switching losses take up the substantial proportion of the total losses. Dissipation of the not inconsiderable power losses often requires heat sinks or the like, which not infrequently take up the largest part of the volume of the electronic circuit.

In order to reduce the switch-on losses of transistors, for example, coils are connected in series with the transistor. Through appropriate dimensioning of the coil, it is possible to delay the switch-on current, as a result of which it is possible to reduce the power loss, characterized by the integral of the product of current and voltage. In a similar manner, a capacitors can also be used in parallel with the transistor for reducing the rate of voltage rise. However, the maximum operating frequency of the electronic valve is greatly reduced by the inductance or capacitance. Moreover, the power loss normally occurring in the transistor is dissipated in another component, e.g. in attenuation resistors connected in series with the coil or the capacitor, which means that what occurs is de facto only a displacement but not an actual reduction of the power loss.

Such saturation coils or stepped inductors for reducing the switch-on losses of electronic valves are disclosed for example in DE 35 42 751 A1, DE 33 34 794 A1 or DE 28 29 840 A1.

In order to reduce the switch-off losses, it is known to use quasi resonant circuits which, however, do not enable complete switch-off load relief of the valve.

When using thyristors as electronic valves, the document “Leistungselektronik: Grundlagen und Anwendungen” [“Power Electronics: Principles and Applications”] by Rainer Jäger, VDE-Verlag Berlin 1980, pages 165-181, for example, discloses, for the purpose of turning off the thyristor, arranging a further thyristor in parallel via a capacitor. In order to ensure a periodic function of the thyristor, use is made of an oscillation-reversal circuit arranged in parallel with the auxiliary thyristor. The capacitor is subjected to charge reversal via said oscillation-reversal circuit, which comprises an inductance and diode in series, for example. However, a reduction of the switching losses of the thyristor is not achieved by the arrangement.

In order to reduce both the switch-on and the switch-off losses, compromises are usually made between valve load relief and maximum operating frequency, since it has not been possible hitherto to unite the circuits for reducing the switch-on losses and the switch-off losses in conjunction with a reasonably high operating frequency.

Known methods for limiting the switching losses of electronic valves have the disadvantage that once again power is converted into heat in the externally connected components and effectively the power loss is only displaced from the electronic valve into other components. The reduction of the peak power losses is often realized only by buffer-storage of the power, which loads the electronic valve in a time-delayed manner.

By way of example, U.S. Pat. No. 5,341,004 A discloses a semiconductor circuit with reduced switching losses in which a second semiconductor element is applied in parallel with the semiconductor element, for example the transistor, said second semiconductor element being of the same type as the first semiconductor element. The second semiconductor element has a higher saturation voltage and a shorter fall time than the first semiconductor element. By virtue of the fact that the faster semiconductor element accepts the current during the switch-off phase, the switch-off losses of the first semiconductor element can be reduced in accordance with the shortened switching time.

The same circuit arrangement is also shown in JP 6290863 A, for example.

It is an object of the invention to achieve as effective a reduction as possible both of the switch-on and of the switch-off losses in electronic valves. At the same time, the intention is to avoid or at least reduce the disadvantages of known systems. The maximum frequency of the electronic valve is intended not to be significantly reduced by the circuit according to the invention and the circuit according to the invention is to be as simple as possible and thus cost-effective.

The object of the invention is achieved by virtue of the fact that, via a capacitor, an electronic auxiliary valve is arranged in parallel with the electronic valve and a series circuit comprising at least an inductance and a diode for discharging the capacitor is arranged in parallel with the electronic auxiliary valve, the electronic auxiliary valve being driven before the switch-off operation of the electronic valve, so that the auxiliary valve accepts the current flowing through the electronic valve and the power loss of the electronic valve is thus minimized during the switch-off operation. The saturation coil—known per se—connected in series with the electronic valve has an inductance which is variable as a function of time or current and is as large as possible during the switching-on of the electronic valve and is as small as possible after the switch-on operation, so that the current is delayed relative to the voltage of the electronic valve during the switch-on operation and the power loss of the electronic valve is minimized during the switch-on operation. Said inductance ensures that the current is delayed during a switch-on operation to an extent such that the power loss occurring in the electronic valve, characterized by the integral of the product of the voltage and the current, is virtually negligible, while the inductance decreases after the switching operation to such a great extent that the maximum operating frequency of the electronic valve is not significantly limited. In this case, the coil can be arranged at any desired location in the current path of the electronic valve. The electronic auxiliary valve arranged in parallel with the electronic valve via a capacitor is driven before the switch-off operation of the electronic valve, so that the circuit branch accepts the current flowing through the electronic valve. As a result, the power loss of the electronic valve is also minimized during the switch-off operation. A series circuit at least comprising an inductance and a diode for discharging the capacitor is provided in parallel with the auxiliary valve. As a consequence both of the reduced switch-on losses and of the reduced switch-off losses, circuits with such electronic valves can be made significantly smaller since the heat sinks do not have to be as large or the electronic valves themselves can be given smaller dimensions. Equally, it is possible to increase the efficiency of circuits with such electronic valves.

If a saturation coil for reducing the switch-on losses of the auxiliary valve is arranged in series with the electronic auxiliary valve, the total switching losses can be reduced further.

In accordance with a further feature of the invention, the nonlinearity of the inductance of the coil is achieved by virtue of the fact that the latter is formed by an inductor with a magnetic core, and that the inductor is dimensioned in such a way that it attains saturation directly after the switch-on operation of the electronic valve or of the electronic auxiliary valve. At saturation, the inductor loses its inductive reactance since all elementary magnets of the core material are magnetized. Consequently, the inductor does not constitute a limitation of the effectively practical operating frequency. Since the inductor at saturation also hardly stores energy anymore in the magnetic field, the losses and generated overvoltages and the energy content thereof are also very small and can be fed back into the supply, for example, by suitable circuits. The time and nature of the transition of the inductor to saturation can be precisely defined through the choice of the material of the magnetic core, the number of turns, the core volume and the voltage. As a result, the circuit according to the invention for reducing the switch-on losses can be exactly adapted to the respective applications.

In order to obtain the least possible outlay on hardware, it is provided that a microcontroller is provided for controlling the electronic valves and electronic auxiliary valves. As a result, the circuit can be adapted relatively simply to different uses.

The features of the present invention are described in more detail with reference to the accompanying figures, in which:

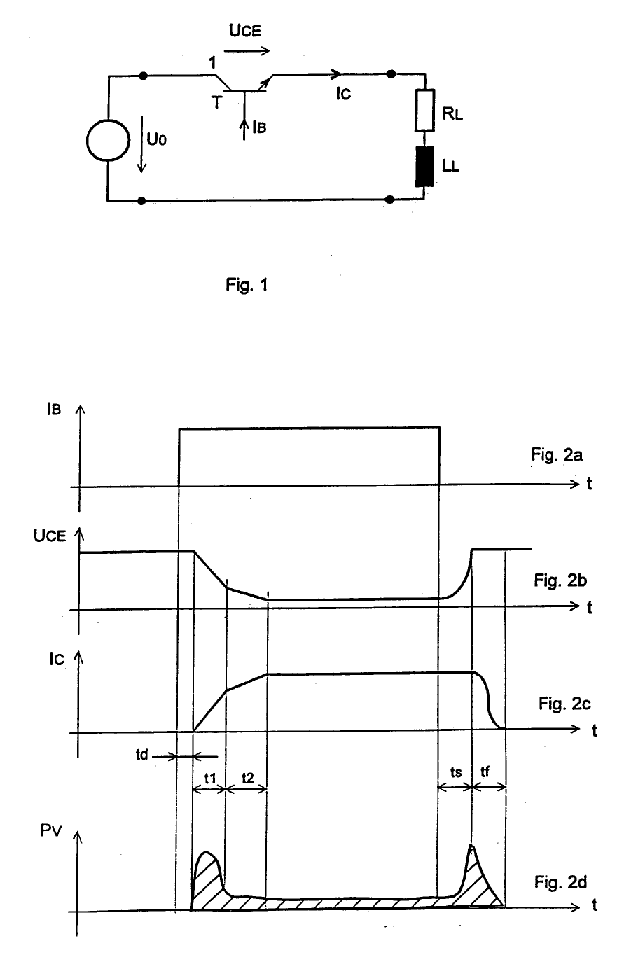

FIG. 1 shows a schematic circuit comprising a transistor as electronic valve,

FIGS. 2a-2d show the time profiles of a few characteristic quantities in accordance with FIG. 1,

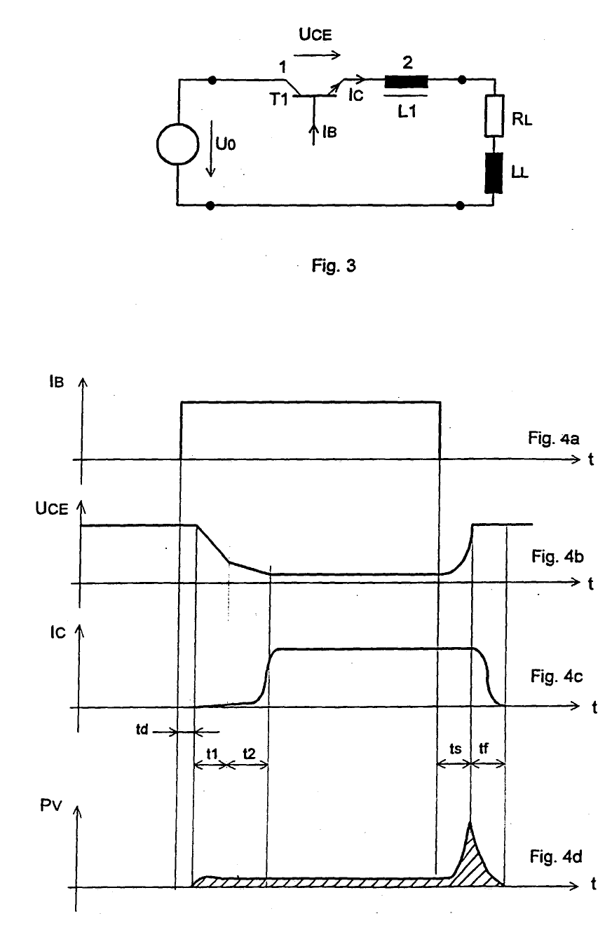

FIG. 3 shows the circuit in accordance with FIG. 1 with a saturable indicator for reducing the switch-on losses,

FIGS. 4a-4d show the time profiles of a few characteristic quantities in accordance with FIG. 3, and

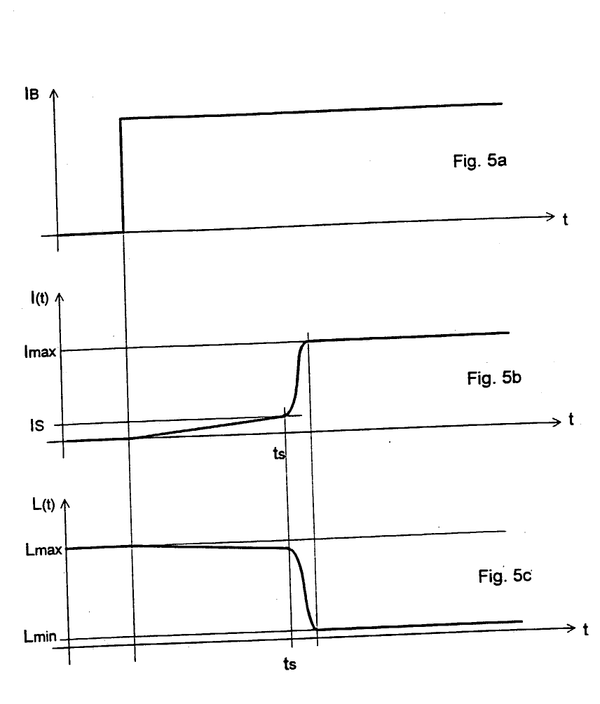

FIGS. 5a-5c show the time profiles of the switching current, the current through the saturable indicator and the inductance of the saturable indicator during a switch-on operation,

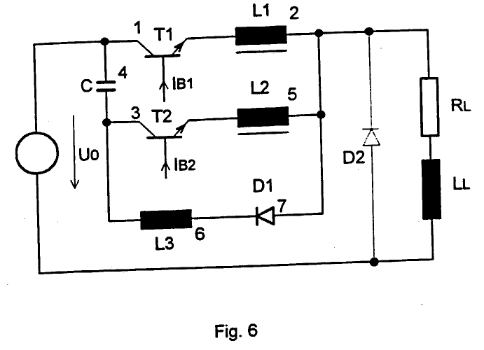

FIG. 6 shows an embodiment variant of the circuit according to the invention for the combined reduction of the switch-on and switch-off losses of transistors, and

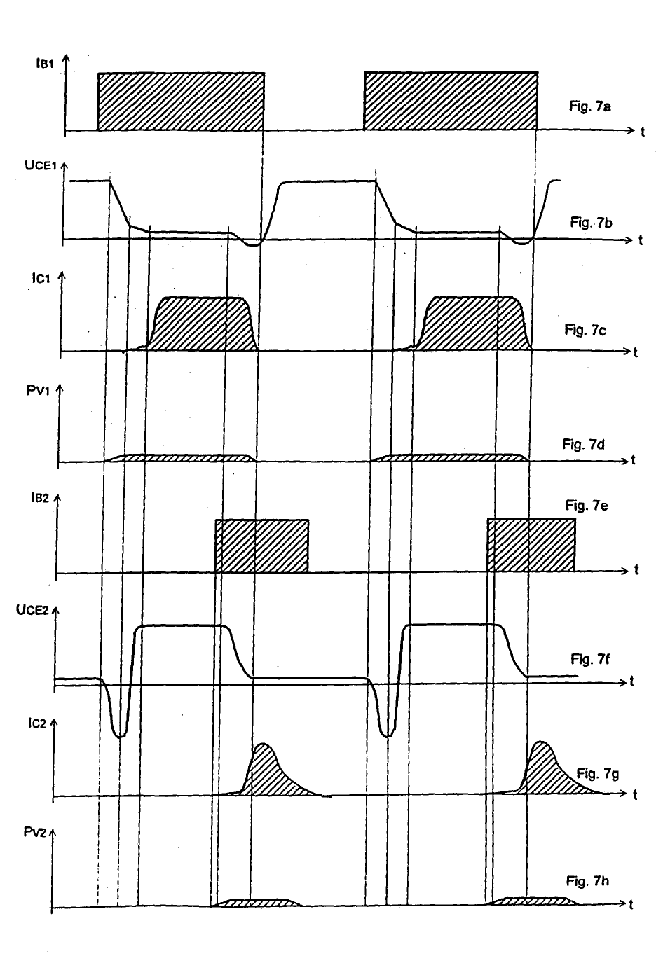

FIGS. 7a-7h show the time profiles of a few characteristic quantities of the circuit in accordance with FIG. 6.

FIG. 1 shows a transistor T as electronic valve. The transistor T switches a voltage U₀ through to a load, represented by a series circuit comprising a load resistance R_{L} and a load inductance L_{L}. To control the circuit, a corresponding base current I_{B} is applied to the base of the transistor T.

The time profiles of the base current I_{B}, of the collector-emitter voltage U_{CE}, of the collector current I_{C} and of the resulting power loss P_{V} during a switch-on and switch-off operation of the transistor are illustrated in FIGS. 2a to 2d. The profiles are only schematic illustrations. After switch-on, the collector current I_{C} gradually rises after a certain switch-on delay time t_{d} to its maximum value. The collector-emitter voltage U_{CE} gradually falls to a minimum value dependent on the transistor type and the collector current I_{C}. During the switch-off operation, the collector-emitter voltage U_{CE} gradually rises again during the so-called storage time t_{S} and the collector current I_{C} then falls to a negligible residual current. The power loss P_{V} during a time period Δt=t_{B}−t_{A} is determined by the following relationship:

$${P}_{V} = {\int }_{{t}_{A}}^{{t}_{B}} {u}_{CE} ( t ) {i}_{C} ( t ) ⅆ t$$

It can clearly be seen from the profile of the power loss P_{V} in accordance with FIG. 2d that relatively high peak power losses occur during the switch-on phase and during the switch-off phase. Between the switch-on and switch-off phases, the total power loss P_{V} is determined merely by the on-state power loss. In order to reduce the power loss P_{V} during the switching operations, it is necessary to keep the voltage or the current as low as possible during the switch-on and switch-off operation in accordance with the above formula, so that the integral over the product of voltage and current is as small as possible.

FIG. 3 shows a simplified circuit of an electronic valve in the form of a transistor T₁ with a saturable indicator L₁ in series. The location at which the inductance L₁ is interposed is irrelevant in this case. Given suitable dimensioning of the saturable indicator L₁, the switch-on losses can be virtually completely eliminated, as a result of which only the on-state losses and the switch-off losses are now critical for the heat balance of the transistor T₁ and of the electronic valve and the switching frequency is limited neither by thermal losses nor by excessively short current rise and fall times.

By considering FIGS. 4a to 4d, which show the time profiles of the base current I_{B}, of the collector-emitter voltage U_{CE}, of the collector current I_{C} and of the resulting power loss P_{V} during a switch-on and switch-off operation of the transistor T₁ in accordance with the circuit of FIG. 3, the advantage becomes clear in comparison with FIGS. 2a to 2d. After the switch-on operation by increasing the base current I_{B}, the slope of the current I_{C} is reduced as far as possible by the saturable indicator L₁. With the use of a normal inductance, the rise in the collector current would, however, be reduced to such an extent by this measure that the maximum achievable switching frequency of the transistor T₁ would become impermissibly small. For this reason, it is endeavored to ensure that, after the fall in the collector-emitter voltage U_{CE}, the collector current I_{C} rises as rapidly as possible. This is achieved by the use of a saturable indicator L₁ with a magnetic core which is dimensioned in such a way that it attains saturation immediately after the fall in the collector-emitter voltage U_{CE} and thus has a very low inductance. At this point in time, the product of collector-emitter voltage U_{CE} and collector current I_{CE} no longer makes a significant contribution to the switch-on power loss. This measure makes it possible to reduce the switch-on losses in such a way that they are negligible compared with the on-state losses.

FIG. 5a shows the base current I_{B} of the transistor T₁, which represents the switch-on operation of this controlled semiconductor. FIG. 5b outlines the corresponding time profile of the current I(t) through the saturable indicator L₁ and FIG. 5c the inductance L(T) of the saturable indicator L₁ as a function of time t during the switch-on operation. After switch-on, the current rises only very slowly through the relatively high inductance of the saturable indicator L₁. What can be achieved through appropriate dimensioning of the saturable indicator L₁ is that the saturable indicator L₁ attains saturation at a precisely defined current I_{S}, given by the operating voltage and the switch-on time already elapsed. The region of core saturation is characterized in that the magnetic flux Φ or the induction B cannot be appreciably increased despite an increase in the current in the saturable indicator L₁. In the region of saturation, approximately all of the elementary magnets of the core material are oriented in the preferred direction. In the region of saturation, the inductive reactance of the winding decreases, as a result of which only the undesirable resistive component of the reactance limits the current in the winding. Therefore, the inductance of the saturable indicator L₁ falls to a minimum value Lₘᵢₙ. The latter is determined principally by the number of turns and the core material of the saturable indicator L₁. The current I(t), by contrast, now rises more rapidly to its maximum value Iₘₐₓ limited by the load. The inductor L₁ is preferably dimensioned by suitable selection of the magnetic core material, the number of turns and the core volume. These parameters influence not only the point in time tₛ at which the inductance L₁ attains saturation, but also the behavior concerning how the transition to saturation takes place, i.e. for example the rate of current rise in the region of saturation of the saturable indicator L₁.

FIG. 6 shows a circuit according to the invention for the combined reduction of the switch-on and switch-off losses of a transistor T₁. Compared with the circuit in accordance with FIG. 3, an auxiliary transistor T₂ with a further saturable indicator L₂ is connected, via a capacitor C, in parallel with the transistor T₁ and the saturable indicator L₁ connected in series therewith. The saturable indicator L₂ minimizes the switch-on losses of the auxiliary transistor T₂ in the same way as saturable indicator L₁ minimizes the switch-on losses of the main transistor T₁. The diode D₁ and inductance L₃ connected in parallel with the auxiliary transistor T₂ and the saturable indicator L₂ serve for the polarity reversal of the capacitor C after a switching cycle, thereby creating the initial conditions for a further switching cycle. A diode D₂ is often used in parallel with the output (load R_{L} and L_{L}), which diode enables the demagnetization of the inductance L_{L}, thereby preventing the consequence of impermissibly high voltage spikes during switch-off.

The method of operation of the circuit in accordance with FIG. 6 is explained in more detail with reference to the time profiles in accordance with FIGS. 7a to 7h, which illustrate the time profiles of the base current I_{B1}, of the collector-emitter voltage U_{CE1}, of the collector current I_{C1} and of the resulting power loss P_{V1} of the transistor T₁ and of the base current I_{B2}, of the collector-emitter voltage U_{CE2}, of the collector current I_{C2} and of the resulting power loss P_{V2} of the auxiliary transistor T₂ during a switch-on and switch-off operation of the transistor T−₁. The switch-on operation of the main transistor T₁ corresponds to that which has already been illustrated and explained in FIGS. 4a to 4d. Before the switch-off operation, the auxiliary transistor T₂ is activated by a corresponding base current I_{B2}. The collector current I_{C2} likewise rises in a delayed manner due to the inductor L₂. The secondary branch formed by the transistor T₂ finally accepts the current, so that after the maximum of the collector current I_{C2} has been reached, the main transistor T₁ does not carry a collector current I_{C1}, anymore and can be switched off by the base current I_{B1}. Since the collector current I_{C1} of the transistor T₁ has already fallen to its minimum at this point in time, the switch-off power loss of the transistor T₁ is reduced to a minimum. The current I_{C2} falls independently on account of the charge of the capacitor C. At the time when the transistor T₂ is switched off, the latter only carries a minimal residual current I_{C2}, so that the power loss is likewise reduced during the switch-off of T₂. The negative collector-emitter voltage U_{CE2} after the switch-on operation of the transistor T₁ stems from the oscillation-reversal operation of the capacitor C via the diode D₁ and the inductance L₃. The circuit according to the invention reduces the switching losses by combating the cause, namely the simultaneous occurrence of a current and a voltage.

The circuitry according to the invention is distinguished by particular simplicity and particular effectiveness. As a result, all circuits which contain electronic valves or switches can be made significantly smaller or supply a higher output power given the same volume.

The circuits according to the invention afford particular advantages when used in devices in which very high currents and/or voltages and therefore also very high power losses occur. These include welding devices, for example, in which very high currents usually occur, or else ballasts for gas discharge lamps.

1. A circuit for reducing the switching losses of electronic valves, a saturation coil (2) for reducing the switch-on losses being arranged in series with the electronic valve (1), characterized in that, via a capacitor (4), an electronic auxiliary valve (3) is arranged in parallel with the electronic valve (1) and a series circuit comprising at least an inductance (6) and a diode (7) for discharging the capacitor (4) is arranged in parallel with the electronic auxiliary valve (3), the electronic auxiliary valve (3) being driven before the switch-off operation of the electronic valve (1), so that the auxiliary valve (3) accepts the current flowing through the electronic valve (1) and the power loss of the electronic valve (1) is thus minimized during the switch-off operation.

2. The circuit as claimed in claim 1, characterized in that a saturation coil (5) for reducing the switch-on losses of the auxiliary, valve (3) is arranged in series with the electronic auxiliary valve (3).

3. The circuit as claimed in claim 1 or 2, characterized in that the saturation coil (2, 5) is formed by an inductor with a magnetic core, and in that the inductor is dimensioned in such a way that it attains saturation directly after the switch-on operation of the electronic valve (1) or of the electronic auxiliary valve (3).

4. The circuit as claimed in one of claims 1 to 3, characterized in that a microcontroller is provided for controlling the electronic valves (1) and electronic auxiliary valves (3).
